(19) United States
(12) Patent Application Publication
(10) Pub. No.: US 2015/0278695 A1
(43) Pub. Date: Oct. 1, 2015

(54) REACHING A GOAL STATE USING A PLURALITY OF FLOWCHARTS

(71) Applicant: Sehul S. SHAH, Fremont, CA (US)

(72) Inventor: Sehul S. SHAH, Fremont, CA (US)

(21) Appl. No.: 14/226,614

(22) Filed: Mar. 26, 2014

(51) Int. Cl. G06N 5/04; G06F 3/0484

(52) U.S. Cl. CPC G06N 5/045; G06F 3/04842

(57) ABSTRACT

Processes for reaching a goal state using a plurality of flowcharts are described. In one example, a selection of a plurality of flowcharts is received via input to a graphical user interface (GUI). A question of a first decision node of a first flowchart is caused to be displayed on the GUI and an answer to the question is received via input to the GUI. A determination is made whether a question of a first decision node of a second flowchart can be answered by a first stored answer. In response to determining that the question of the first decision node of the second flowchart cannot be answered by the first stored answer, the question of the first decision node of the second flowchart is caused to be displayed on the GUI and an answer to the question is received via input to the GUI.

### BACKGROUND

1. Field

The present disclosure relates generally to digital content systems and, more specifically, to reaching a goal state using a plurality of flowcharts.

2. Related Art

Consumers frequently rely on the Internet as a convenient resource for assisting with decision-making or goal-reaching. For example, consumers may perform research on the internet to determine whether to purchase a car or how to fix a leaking faucet. Some internet sites offer access to flowcharts that help consumers with their decision-making or goal-reaching. For example, an internet site may offer access to a flowchart representing a process for determining whether to purchase a car. By following the process outlined by the flowchart, a consumer would reach a conclusion recommending whether to purchase a car. However, a consumer may encounter multiple flowcharts representing different processes for making the same decision or reaching the same goal. The consumer may need to spend significant amounts of time navigating through the multiple flowcharts to determine the best process to follow. Additionally, several different conclusions may be reached based on the multiple flowcharts, thereby making it difficult to ultimately make a decision or reach a goal.

### SUMMARY

In exemplary processes for reaching a goal state using a plurality of flowcharts described herein, a selection of a plurality of flowcharts is received via input to a graphical user interface. The plurality of flowcharts represents processes for reaching a same goal state and includes a first flowchart and a second flowchart. A question of a first decision node of the first flowchart is caused to be displayed on the graphical user interface and an answer to the question of the first decision node of the first flowchart is received via input to the graphical user interface. A determination is made whether a question of a first decision node of the second flowchart can be answered by a first stored answer. In response to determining that the question of the first decision node of the second flowchart cannot be answered by the first stored answer, the question of the first decision node of the second flowchart is caused to be displayed on the graphical user interface and an answer to the question of the first decision node of the second flowchart is received via input to the graphical user interface.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary flowchart representing a process for reaching a goal state.

FIG. 2 illustrates an exemplary process for reaching a goal state using a plurality of flowcharts.

FIG. 3 illustrates two exemplary flowcharts representing processes for reaching a goal state.

FIG. 4 illustrates an exemplary graphical user interface for carrying out aspects of the process described.

FIG. 5 illustrates an exemplary graphical user interface for carrying out aspects of the process described.

FIG. 6 illustrates an exemplary graphical user interface for carrying out aspects of the process described.

FIG. 7 illustrates an exemplary graphical user interface for carrying out aspects of the process described.

FIG. 8 illustrates an exemplary graphical user interface for carrying out aspects of the process described.

FIG. 9 illustrates an exemplary graphical user interface for carrying out aspects of the process described.

FIG. 10 illustrates an exemplary graphical user interface for carrying out aspects of the process described.

FIG. 11 illustrates an exemplary process for reaching a goal state using a plurality of flowcharts.

FIG. 12 illustrates a system and environment for carrying out aspects of the processes described.

FIG. 13 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

In exemplary processes for reaching a goal state using a plurality of flowcharts described herein, a selection of a plurality of flowcharts is received via input to a graphical user interface. The plurality of flowcharts represents processes for reaching a goal state and includes a first flowchart and a second flowchart. A question of a first decision node of the first flowchart is caused to be displayed on the graphical user interface and an answer to the question of the first decision node of the first flowchart is received via input to the graphical user interface. A determination is made whether a question of a first decision node of the second flowchart can be answered by a first stored answer. In one example, the first stored answer may be an answer based at least partially on stored information. In another example, the first stored answer may be the answer to the question of the first decision node of the first flowchart. In response to determining that the question of the first decision node of the second flowchart cannot be answered by the first stored answer, the question of the first decision node of the second flowchart is caused to be displayed on the graphical user interface and an answer to the question of the first decision node of the second flowchart is received via input to the graphical user interface. In response to determining that the question of the first decision node of the second flowchart can be answered by the first stored answer, an answer to the question of the first decision node of the second flowchart may be pre-selected based on the first stored answer. The user may accept the pre-selected answer or select a different answer. This enables a user to navigate through the plurality of flowcharts more efficiently and reach a goal state more quickly. Additionally, because multiple recommendations may be obtained based on the conclusions of the plurality of flowcharts, the user may reach a final conclusion with greater confidence. Accordingly, exemplary processes described herein may be used to reach a goal state more quickly and with greater confidence.

### 1. Flowcharts

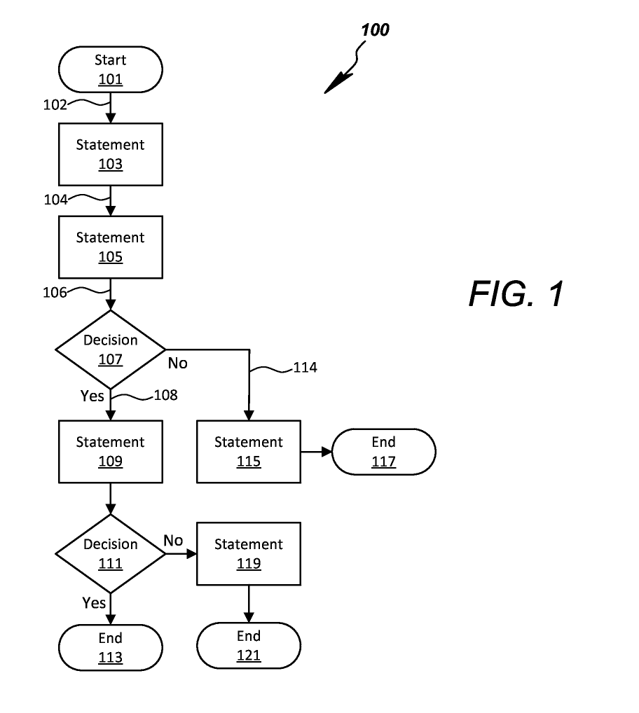

FIG. 1 illustrates an exemplary flowchart 100. Flowchart 100 includes multiple nodes connected by multiple logic paths. For example, logic path 106 connects from statement node 105 to decision node 107. Flowchart 100 may represent a process for reaching a goal state. Reaching a goal state may include, for example, reaching a decision, answering a question, solving a problem, achieving a goal, or determining that a goal is not achievable. In one example, flowchart 100 may represent a process for determining whether to purchase a car. Each node of flowchart 100 may represent a step in the process. By navigating through flowchart 100 and following the steps represented by the nodes of flowchart 100, a user can reach an end node representing a particular conclusion. For example, the user may reach an end node of flowchart 100 representing the conclusion that a car should be purchased. By reaching an end node of flowchart 100, the user thus reaches the goal state.

As shown in FIG. 1, flowchart 100 begins at start node 101 and logically concludes at end nodes 113, 117, 121. As described above, end nodes 113, 117, 121 may represent conclusions to the process represented by flowchart 100. Statement nodes 103, 105, 109, 115, 119 and decision nodes 107, 111 are disposed between start node 101 and end nodes 113, 117, 121. A statement node may include a statement having instructions or relevant information regarding the represented step in the process. For example, a statement of a statement node may include instructions for a task that should be performed at that step in the process. In addition, a statement of a statement node may include an intermediate conclusion. Decision nodes 107, 111 may include questions (e.g., a “yes/no” question) that direct the user to the appropriate logic path. For example, decision node 107 may include a question asking the user whether they live more than five miles from their workplace. The answer to that question would determine whether the user should follow logic path 108 to statement node 109 or logic path 114 to statement node 115.

In the present example, flowchart 100 is a streamline flowchart. A streamline flowchart has several restrictive features that streamline the flowchart. One restrictive feature of flowchart 100 may be that flowchart 100 has only four types of nodes: start node, end nodes, statement nodes, and decision nodes. A limited number of node types is advantageous in making flowchart 100 simple and easy to create, edit, navigate, save and analyze. It should be recognized that in other examples, flowchart 100 may have more than four types of nodes.

Another restrictive feature of flowchart 100 may be that each statement node and decision node of flowchart 100 is connected only to a limited number of logic paths. In this example, each statement node is only connected to two logic paths: one flowing to the statement node and one flowing from the statement node. For example, statement node 103 is only connected to logic path 102 flowing to statement node 103 from start node 101 and logic path 104 flowing from statement node 103 to statement node 105. Restricting the number of logical paths connected to each statement node simplifies the flowchart, thus making it easier for users to navigate through the flowchart.

In the present example, each decision node is only connected to three logic paths: one flowing to the decision node and two flowing from the decision node. For example, decision node 107 is connected to logic path 106 which flows to decision node 107 and logic paths 108, 114 which flows from decision node 107. Having only two logic paths flowing from each decision node restricts the question of each decision node to one having only two possible answers. In one example, the question of each decision node may prompt either a “yes” or a “no” response. In other cases, flowchart 100 may have three logic paths flowing from each decision node. In such cases, the question of each decision node may have only three possible answers. For example, the question of each decision node may prompt a “yes,” a “no,” or a “maybe” response. Limiting the questions of decision nodes to those having a limited number of answers simplifies the questions presented to users and thus makes it more efficient for users to navigate through the flowchart.

Yet another restrictive feature of flowchart 100 may be that the statement of each statement node and the question of each decision node are restricted to a character length limit. In one example, the character length limit may be 160 characters or less. In another example, the character length limit may be 200 characters or less. This keeps the statements and questions of the nodes short and direct, thereby preventing confusion that may be caused by lengthy statements or compound questions. Additionally, the character length limit may enable the use of SMS/texting platforms for navigating through flowchart 100.

The restrictive features described above enable streamline flowcharts to be easier and more efficient to navigate through. Additionally, the restrictive features enable the nodes of a plurality of flowcharts to be compared more quickly and easily. Thus, processes for reaching of a goal state using a plurality of flowcharts described herein may be performed more efficiently using streamline flowcharts.

### 2. Process for Reaching a Goal State Using a Plurality of Flowcharts.

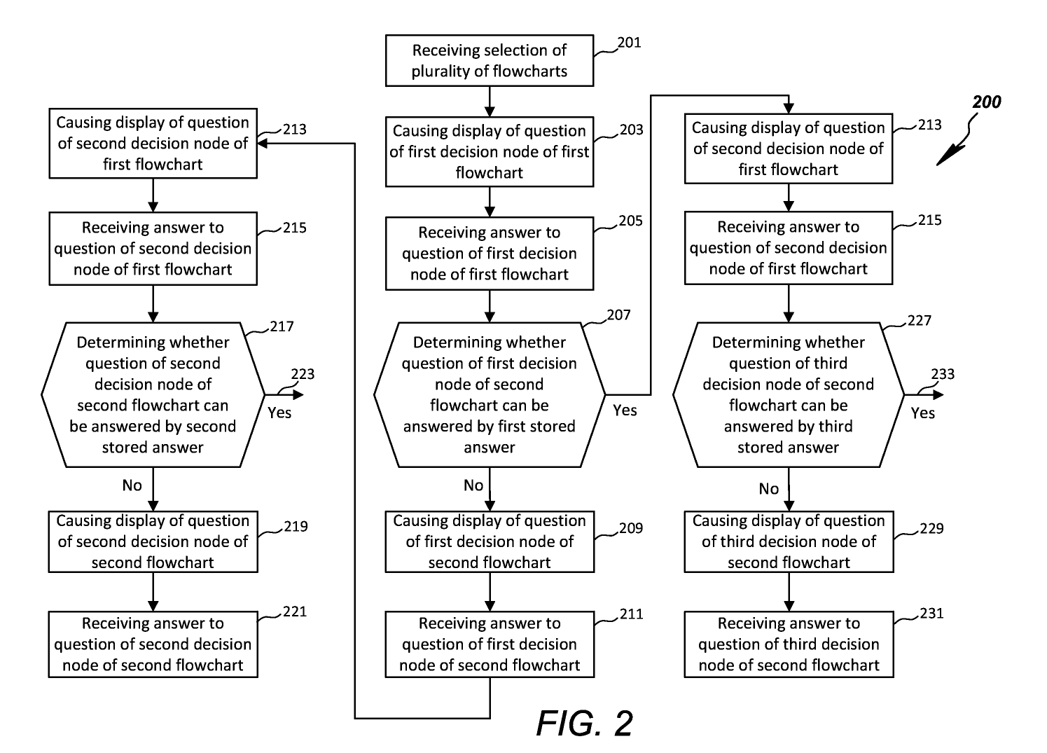

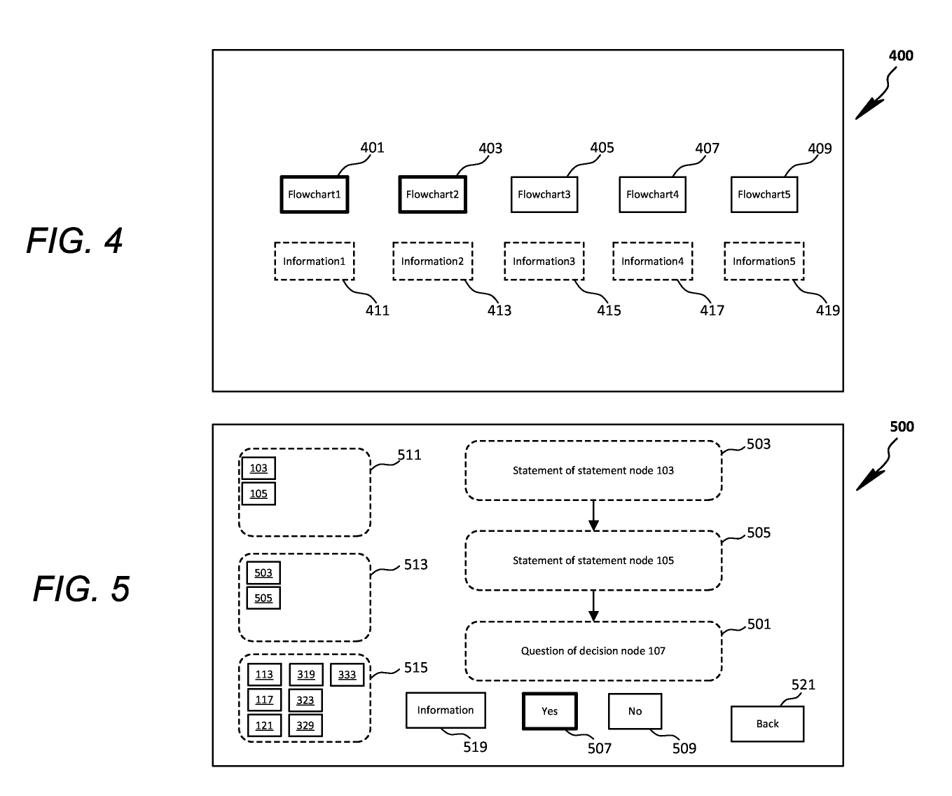

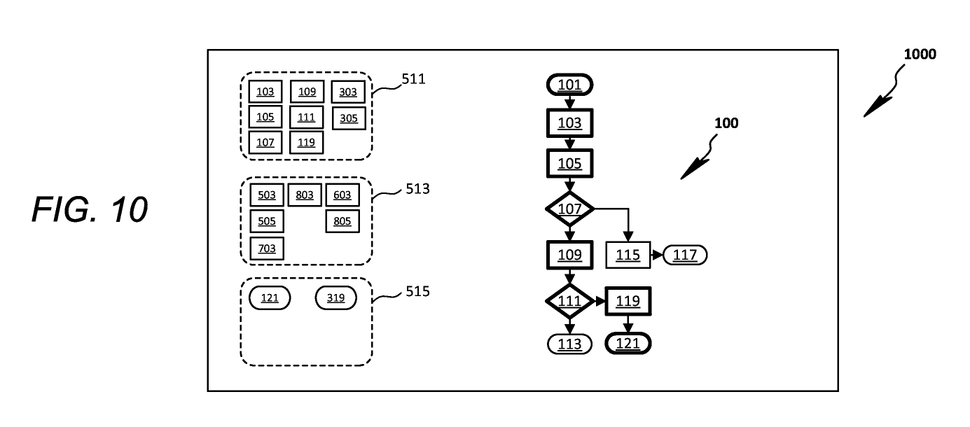

FIG. 2 illustrates an exemplary process 200 for reaching a goal state using a plurality of flowcharts. FIGS. 4-10 illustrate exemplary graphical user interfaces (GUIs) for carrying out aspects of process 200 described herein. Process 200 is described with simultaneous reference to FIGS. 2 and 4-10.

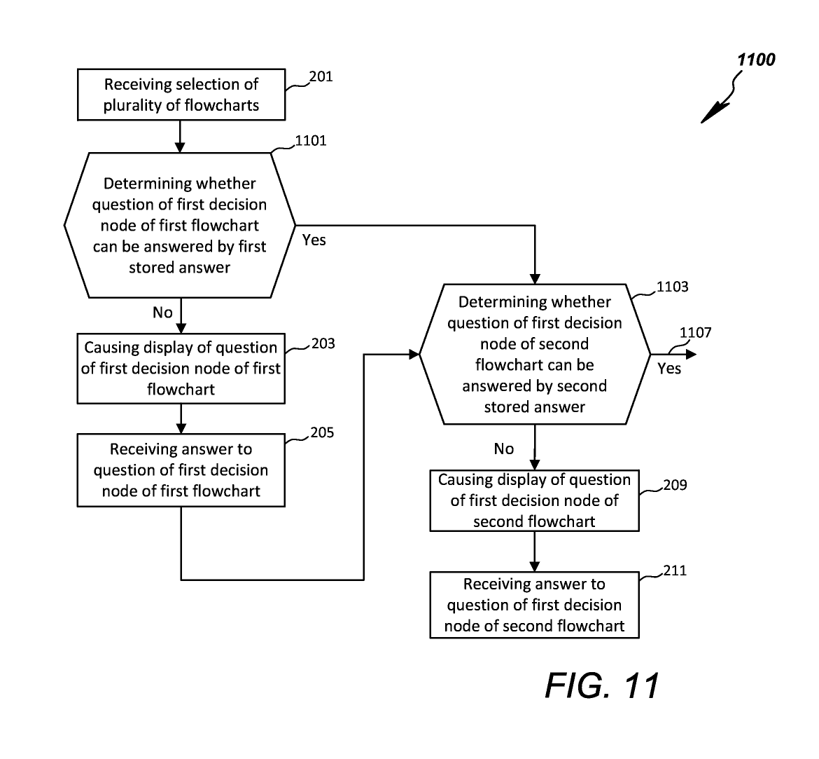

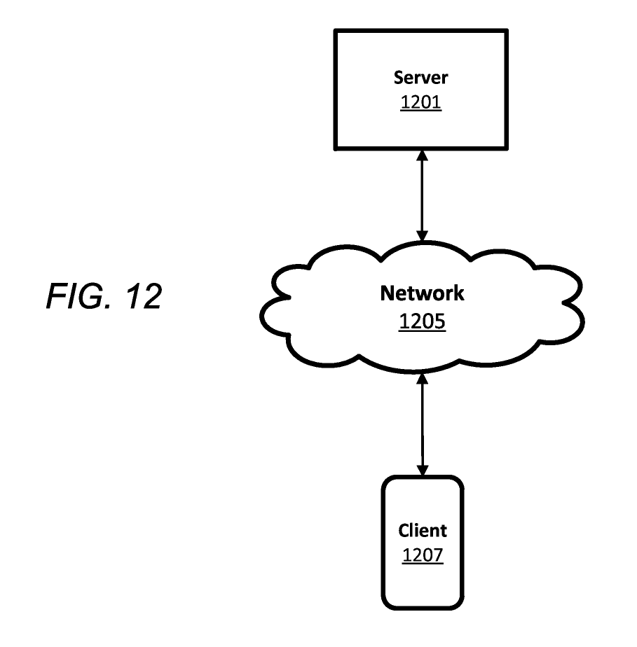

At block 201 of process 200, a selection of a plurality of flowcharts may be received via input to a GUI. For example, with reference to FIG. 4, GUI 400 may be caused to be displayed on a screen of a client device by a server system. A user may select a first flowchart and a second flowchart from five flowcharts via input to GUI 400. The selection of the first and second flowcharts may be sent by the client device to the server system via a network and received by the server system. The use of a client device, server system, and network to carry out aspects of process 200 are described later in greater detail with reference to FIGS. 11 and 12.

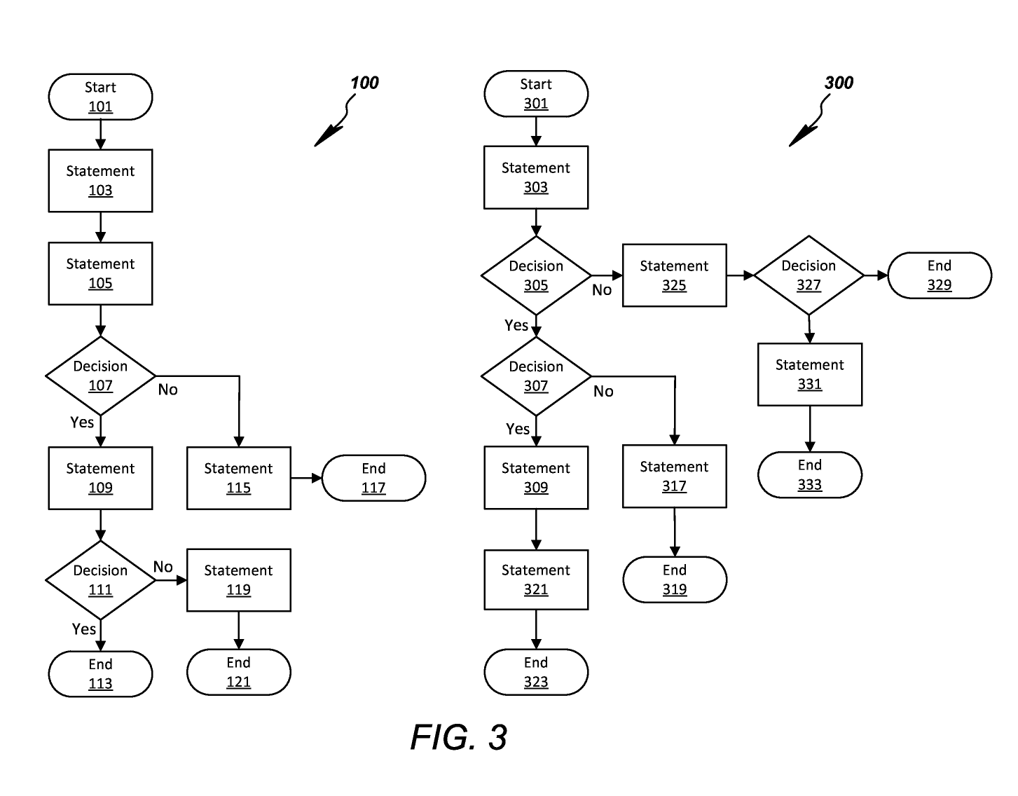

As shown in FIG. 4, GUI 400 includes GUI elements 401-409 representing five flowcharts. Each flowchart of the five flowcharts represents a process for reaching the same goal state. For example, each flowchart may represent a process for determining whether to purchase a car. The processes may include different approaches to reaching the same goal state. In this example, GUI elements 401, 403 represent flowcharts 100, 300 of FIG. 3, respectively. Further, each flowchart represented by GUI elements 401-409 is a streamline flowchart. As described above, streamline flowcharts are advantageous in enabling users to reach a goal state more efficiently.

Although in this example, GUI 400 includes five GUI elements representing a group of five flowcharts, it should be recognized that in other examples, GUI 400 may include any number of GUI elements representing a corresponding number of flowcharts for reaching the same goal state. GUI 400 may provide access to multiple groups of flowcharts. Each group of flowcharts may include flowcharts for reaching a particular goal state. For example, one group of flowcharts may include flowcharts for determining a suitable location for a vacation. Another group of flowcharts may include flowcharts for repairing a leaking faucet. A user may thus select a plurality of flowcharts, including a first and a second flowchart, from a group of flowcharts for reaching a desired goal state.

As shown in FIG. 4, information 411-419 may be caused to be displayed on GUI 400. Information 411-419 includes information associated with the five flowcharts. For example, information 411-419 may include the name of the author of each flowchart, the overall user rating of each flowchart, the overall user rating of the author of each flowchart, the total number of user ratings on which the overall user rating is based, or the percentage of previous users that selected each flowchart. The overall user rating of each flowchart and the overall user rating of the author of each flowchart may be based at least partially on the user ratings by previous users. The user ratings may be based at least partially on the users' subjective or objective opinions of the quality of each flowchart. Further, information 411-419 may include the percentage of decision nodes having questions that can be answered by stored answers for each flowchart. This enables the user to identify flowcharts for which a conclusion may be reached quickly. Accordingly, information 411-419 allows users to make an informed decision when selecting the plurality of flowcharts for reaching a desired goal state.

Each GUI element 401-409 displayed on GUI 400 may have a visually distinguishing characteristic that enables the user to quickly distinguish between each GUI element 401-409. For example, GUI element 401 may have a visually distinguishing characteristic that is different from that of GUI element 403. Visually distinguishing characteristics may include, for example, different colors, shapes, sizes, or symbols. Having visually distinguishing characteristics is advantageous in enabling the user to quickly identify the different flowcharts represented by GUI element 401-409.

In the present example, the user may select a plurality of flowcharts, including a first and a second flowchart, from the five flowcharts by selecting two of GUI elements 401-409 via input to GUI 400. As shown by the bold outlines around GUI elements 401, 403 of FIG. 4, GUI elements 401, 403 are selected via input to GUI 400. Thus, in this example, the first flowchart is flowchart 100 and the second flowchart is flowchart 300. The selection of flowcharts 100, 300 may be sent to the server system by the client device via the network and thus received by the server system. It should be recognized that in other examples, more than two flowcharts may be selected to reach the goal state. Additionally, it should be recognized that the selection of a plurality of flowcharts may, in some cases, be perform automatically without user input to GUI 400. For example, a pre-define criteria may be used to automatically select a plurality of flowcharts. The pre-defined criteria may be based on default settings or pre-defined by a user. For example, the pre-defined criteria may be based at least partially on the overall user ratings of the flowcharts, the overall user ratings of the authors of the flowcharts, the percentages of previous users that selected the flowcharts, or the number of decision nodes in the flowcharts. In some examples, the pre-defined criteria may be executed by the server or the client device to cause the selection of a plurality of flowcharts and the selection of the plurality of flowcharts may be received by the server.

At block 203 of process 200, a question of the first decision node of the first flowchart is caused to be displayed on the GUI. In the present example, with reference to FIG. 3, the user may be directed from start node 101 to decision node 107 via statement nodes 103, 105 without requiring any input from the user. By automatically directing a user through the statement nodes to the subsequent decision node, the user is able navigate through the flowchart more efficiently and thus reach an end node more quickly. With reference to FIG. 5, the server system may cause the display of question 501 of decision node 107 of flowchart 100 on GUI 500. In an example where flowchart 100 represents a process for determining whether to buy a car, question 501 may ask whether the user lives more than five miles from their workplace. Question 501 may be displayed on GUI 500 having similar or identical visually distinguishing features as GUI element 401 of FIG. 4. This enables the user to quickly identify that question 501 originates from flowchart 100.

As shown in FIG. 5, GUI 500 includes GUI elements 507, 509 positioned below question 501. GUI elements 507, 509 represent the answer choices to question 501. In this example, GUI elements 507, 509 represent the answers choices of “yes” and “no”, respectively. The user may input an answer to question 501 via GUI 500 by selecting one of GUI elements 507, 509. In other examples, GUI 500 may include more than two GUI elements. For instance, in an example where the displayed question has three possible answers of “yes,” “no,” and “maybe,” GUI 500 may include three GUI elements representing each of the answer choices. It should be recognized that the position of GUI elements 507, 509 may vary on GUI 500.

As described above, the statement nodes that logically precede the first decision node may be traversed without user input for efficiency. However, in other cases, the statement nodes that logically preceding the first decision node may be caused to be displayed on the GUI to inform the user of the steps or task that immediately precede the first decision node. In the present example, as shown in FIG. 5, statements 503, 505 of statement nodes 103, 105, respectively, may be caused to be displayed above question 501 of decision node 107 on GUI 500. In other examples, statements 503, 505 may be caused to be displayed prior to displaying question 501. Displaying statements 503, 505 may provide context to assist the user in selecting an appropriate answer choice to question 501.

Block 203 may further include causing display of information 519 on GUI 500. Information 519 may be information associated with question 501 of decision node 107 to assist the user in selecting an answer choice. For example, information 519 may include the percentage of previous users that selected each answer choice, the overall user rating of question 501, or the total number of user ratings on which the overall user rating is based. The overall user rating of question 501 may be based at least partially on the subjective or objective opinions of previous users on the quality of question 501. In some examples, information 519 may be caused to be displayed only after the user selects an answer choice to question 501. The user may have the option to change their answer choice to question 501 after information 519 is displayed.

In some cases, GUI 500 may include one or more GUI elements (not shown) for enabling a user to input a user rating of question 501. The inputted user rating may be based at least partially on the user's subjective or objective opinion of the quality of question 501. In one example, GUI elements 507, 509 may be configured to enable the simultaneous input of an answer choice to question 501 and a user rating of question 501. In other examples, GUI 500 may include one or more separate GUI elements to input a user rating of question 501. The inputted user rating may be sent by the client device to the server system via the network and received by the server system.

GUI 500 may include history display region 511 for displaying the navigation history. The navigation history includes all nodes that the user has navigated through for the plurality of flowcharts. In the present example, decision node 107 is under consideration and thus the user has navigated through statement nodes 103, 105. Accordingly, as shown in FIG. 5, statement nodes 103, 105 are displayed in history display region 511. Displaying the navigation history may help a user keep track of previously navigated nodes. Additionally, a node displayed in history display region 511 may be selected by the user to quickly navigate the user back to that node. This provides a convenient way for the user to change a previous answer associated with a decision node. For example, selecting a decision node displayed in history display region 511 may cause the display of the selected decision node on the GUI and enable the user to change their answer associated with the selected decision node.

As shown in FIG. 5, GUI 500 may include task list region 513 for displaying a task list. The task list may include the statements of the statement nodes that the user has navigated through for the plurality of flowcharts. In this example, the user has navigated through statement nodes 103, 105 to reach decision node 107. Accordingly, statements 503, 505 of statement nodes 103, 105, respectively, are displayed in task list region 513. The task list displayed in task list region 513 may be advantageous in helping the user understand the various tasks or actions required for each flowchart to reach the goal state. In addition, the task list may be exported to an external task management tool (e.g., Evernote, Microsoft Office Outlook, Microsoft Office OneNote, etc.), thereby enabling a user to schedule and track their progress in executing the task list.

Further, GUI 500 may include outcome display region 515 for displaying the relevant conclusions of the plurality of flowcharts. The relevant conclusions may include the conclusions of the end nodes of the plurality of flowcharts that logically flow from the node of each flowchart of the plurality of flowcharts that is under consideration. In addition, the relevant conclusions may include the intermediate conclusions of statement nodes that logically flow from the node of each flowchart of the plurality of flowcharts that is under consideration. An intermediate conclusion may be, for example, a statement of a statement node disposed after a decision node that provides useful information to the user regarding an option that may be eliminated as a result of the answer provided to the question of the decision node. Thus, the relevant end nodes define the possible outcomes of a user as the user navigates down each flowchart of the plurality of flowcharts. Understanding the possible outcomes helps a user determine which answer choice to select for a decision node and thus assists the user in navigating through the plurality of flowcharts. In the present example, the user is considering decision node 107 and thus each conclusion of each end node of flowcharts 100, 300 is a relevant conclusion. Accordingly, the conclusions of end nodes 117, 113, 121, 323, 319, 333, 329 are displayed in outcome display region 515. In another example, statement nodes 119, 321 of flowcharts 100, 300 may include intermediate conclusions and thus the intermediate conclusions of statement nodes 119, 321 may be displayed in outcome display region 515.

As shown in FIG. 5, GUI 500 includes GUI element 521 for enabling the user to request the display of a previously displayed GUI or a previously displayed question of a decision node. For example, the selection of GUI element 521 via GUI 500 may cause the display of GUI 400, thereby allowing the user to change their selection of flowcharts among the five flowcharts. In other examples, GUI 500 may not include GUI element 521 to prevent the user from changing previous selections or answers. Thus, the user may navigate down a flowchart of the plurality of flowcharts but is restricted from navigating back up a flowchart of the plurality of flowcharts. In yet other examples, GUI 500 may include a GUI element (not shown) for enabling the user to request the display of a decision node that logically follows the current decision node under consideration.

At block 205 of process 200, an answer to the question of the first decision node of the first flowchart is received via input to the GUI. For example, with reference to FIG. 5, the user may input an answer to question 501 via GUI 500 by selecting one of GUI elements 507, 509. As depicted by the bold outline around GUI element 507 of FIG. 5, GUI element 507 is selected by the user. Accordingly, the user's answer “yes” to question 501 may be sent to the server system by the client device via the network and received by the server system. In some cases, the server system may store the answer to question 501 as a stored answer in response to receiving the answer to question 501. For example, the server system may store the answer to question 501 as a stored answer in memory (e.g., random access memory, solid state memory, media drive units, storage drives, etc.).

With reference to FIG. 3, statement node 109 logically flows from decision node 107 based on the answer “yes” to question 501 of decision node 107. In one example, the statement of statement node 109 may be caused to be displayed on the GUI in response to selecting GUI element 507. In some cases, the statement of statement node 109 may be caused to be displayed on the GUI prior to performing block 207. This enables the user to understand the tasks or statements that logically follows decision node 107.

At block 207 of process 200, a determination is made whether a question of a first decision node of a second flowchart can be answered by a first stored answer. For example, with reference to FIG. 3, the server system may determine whether the question of decision node 305 of flowchart 300 can be answered by a first stored answer. The first stored answer may be an answer at least partially based on stored information. In one example, the first stored answer may be the answer to question 501 of decision node 107 of flowchart 100. In another example, the first stored answer may be at least partially based on an answer to a question of a decision node of a flowchart received prior to receiving the answer to question 501 of decision node 107. The stored information may include any previously collected user information. In one example, the stored information may include information based on answers to questions of decision nodes of flowcharts previously viewed by the user. In another example, the stored information may include information uploaded by the user to facilitate reaching a goal state. The stored information may include demographic information such as age, sex, race, religion, income range, and citizenship. Additionally, the stored information may include other personal user information such as career-related information, personal preferences, and medical history. In yet other examples, the stored information may include any retrievable information stored in an internal or external source (e.g., a local media drive, an external website, a local or remote application, or a remote database). For example, the stored information may include weather, traffic, or stock information retrieved from an Internet resource.

Determining whether the question of decision node 305 can be answered by the first stored answer is advantageous in enabling the user to navigate through the plurality of flowcharts more quickly. For example, in response to determining that a question of a decision node of a flowchart can be answered by a first stored answer, a pre-selected answer to the question based on a first stored answer may be caused to be displayed. A pre-selected answer may reduce the time the user takes to select an answer. As a result, the user may reach the goal state more quickly and efficiently.

As shown in process 200 of FIG. 2, blocks 209 to 217 of process 200 are performed in response to determining that the question of the first decision node of the second flowchart cannot be answered by the first stored answer. For example, the server system may determine that the question of decision node 305 cannot be answered by the first stored answer. In response to the determination, the question of decision node 305 may be presented to the user to obtain an answer.

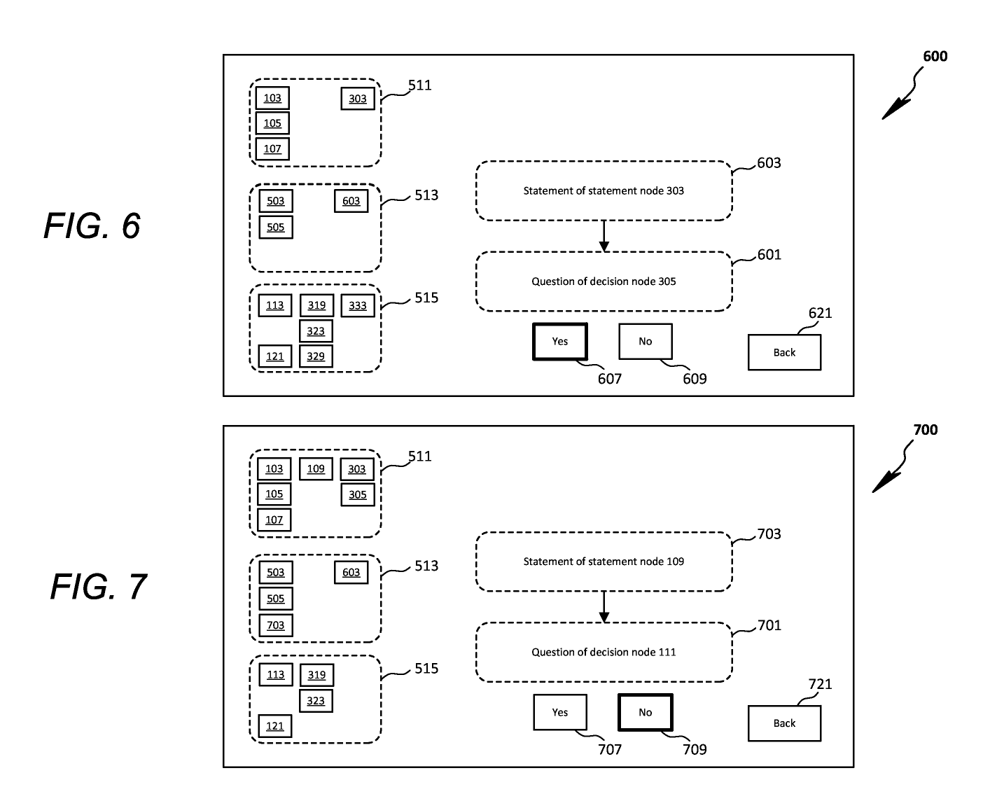

At block 209 of process 200, the question of the first decision node of the second flowchart is caused to be displayed on the GUI in response to determining that the question of the first decision node of the second flowchart cannot be answered by the first stored question. For example, with simultaneous reference to FIGS. 3 and 6, the server system may cause the display of question 601 of decision node 305 of flowchart 300 on GUI 600 in response to determining that question 601 cannot be answered by the first stored answer. Question 601 may be displayed on GUI 600 having similar or identical visually distinguishing features as GUI element 403 of FIG. 4. The visually distinguishing features of question 601 may be different from that of question 501. This may be advantageous in helping the user quickly identify that question 601 originates from flowchart 300.

As shown in FIG. 6, GUI elements 607, 609 are displayed below question 601 and represent the answer choices to question 601. GUI elements 607, 609 function similarly to GUI elements 507, 509 of FIG. 5, respectively. Statement 603 of statement node 303 of flowchart 300 is optionally displayed above question 601 of decision node 305 to inform the user of the statement or task of statement node 303 that logically precedes decision node 305. In some cases, statement 603 of statement node 303 may be caused to be displayed prior to causing the display of question 601 of decision node 305. GUI 600 further includes GUI element 621, which functions similarly to GUI element 521 of GUI 500. In the present example, question 501 of decision node 107 and GUI 500 may be caused to be displayed in response to receiving a selection of GUI element 621. The answer of question 501 may be received prior to receiving the selection of GUI element 621. Accordingly, by selecting GUI element 621, the user may review question 501 or change their answer choice to question 501.

In the present example, decision node 305 is under consideration and thus the user has navigated through nodes 103-107 of flowchart 100, and node 303 of flowchart 300. Accordingly, as shown in FIG. 6, nodes 103-107 of flowchart 100 and node 303 of flowchart 300 are displayed in history display region 511 of GUI 600. Statement 603 of statement node 303 is displayed in task list region 513. Further, the conclusion of end node 117 is no longer relevant because the answer “yes” to question 501 of decision node 107 directs the user to statement node 109, which eliminates the conclusion of end node 117 as a possible outcome. Accordingly, only the conclusions of end nodes 113, 121, 323, 319, 333, 329 are displayed in outcome display region 515.

At block 211 of process 200, an answer to the question of the first decision node of the second flowchart may be received via input to the GUI. For example, with reference to FIG. 6, an answer to question 601 of decision node 305 of the flowchart 300 may be received via input to GUI 600. The user may input an answer to question 601 via GUI 600 by selecting one of GUI elements 607, 609. As depicted by the bold outline around GUI element 607 of FIG. 6, GUI element 607 is selected via input to GUI 600 by the user. The answer “yes” to question 601 is thus sent to the server system by the client device via the network and received by the server system. In some cases, the answer to question 601 may be stored as a stored answer in response to receiving the answer to question 601.

At block 213 of process 200, the question of the second decision node of the first flowchart may be caused to be displayed on the GUI. The second decision node of the first flowchart logically flows from the first decision node of the first flowchart based on the answer to the question of the first decision node of the first flowchart. For example, with simultaneous reference to FIGS. 3 and 7, decision node 111 logically flows from decision node 107, via statement node 109, based on the answer “yes” to question 501 of decision node 107. The server system may thus cause the display of question 701 of decision node 111 of flowchart 100 on GUI 700. Question 701 may be displayed on GUI 700 having similar or identical visually distinguishing features as GUI element 401 of FIG. 4 and question 501 of FIG. 5. This enables the user to quickly identify that question 701 originates from flowchart 100.

As shown in FIG. 7, GUI elements 707, 709 are displayed below question 701 and represent the answer choices to question 701. GUI elements 707, 709 function similarly to GUI elements 507, 509 of FIG. 5, respectively. Statement 703 of statement node 109 of flowchart 100 is optionally displayed above question 701 of decision node 111 to inform the user of the statement or task logically preceding decision node 111 of flowchart 100. Further, GUI 700 includes GUI element 721, which functions similarly to GUI element 521 of GUI 500. In the present example, selecting GUI element 721 via input to GUI 700 may cause the display of question 601 of decision node 305 and GUI 600. The user may therefore review question 601 or change their answer choice to question 601.

In the present example, decision node 111 is under consideration and thus the user has navigated through nodes 103-109 of flowchart 100 and node 303-305 of flowchart 300. Accordingly, as shown in FIG. 7, nodes 103-109 of flowchart 100 and nodes 303-305 of flowchart 300 are displayed in history display region 511 of GUI 700. Statements 503-505, 703, and 603 of statement nodes 103-105, 109, and 303, respectively, are displayed in task list region 513. Further, the conclusions of end nodes 329, 333 are no longer relevant because the answer “yes” to question 601 of decision node 305 directs the user to decision node 307, which eliminates the conclusions of end nodes 329, 333 as possible outcomes. Accordingly, only the conclusions of end nodes 113, 121, 323, 319 are displayed in outcome display region 515.

At block 215 of process 200, an answer to the question of the second decision node of the first flowchart may be received via input to the GUI. For example, with reference to FIG. 7, the user may input an answer to question 701 of decision node 111 via GUI 700 by selecting one of GUI elements 707, 709. As depicted by the bold outline around GUI element 709 of FIG. 7, GUI element 709 is selected by the user. The answer “no” to question 701 may be sent to the server system by the client device via the network and received by the server system. In some cases, the answer to question 701 may be stored as a stored answer in response to receiving the answer to question 701.

With reference to FIG. 3, statement node 119 and end node 121 of flowchart 100 logically flow from decision node 111 based on the answer “no” to question 701 of decision node 111. In one example, the statement of statement node 119 may be caused to be displayed on the GUI in response to selecting GUI element 709. This enables the user to understand the tasks or statements that logically follow decision node 111. The user may then be directed from statement node 119 to end node 121 and thus reach the conclusion of end node 121. In another example, the user may be directed from decision node 111 to end node 121 and traverse through statement node 119 without additional input from the user. The user thus reaches the goal state through the process of flowchart 100. In an example where flowchart 100 represents a process for determine whether to purchase a car, end node 121 may have a conclusion of “yes”. In addition, the conclusion of end node 113 is eliminated as a relevant conclusion when the answer “no” is received for question 701 of decision node 11. Thus, only the conclusions of end nodes 121, 319, 323 would be displayed in outcome display region 515 in response to receiving the answer “no” to question 701 of decision node 111. Further, the statement or task 803 of statement node 119 may be displayed in task list region 513.

At block 217 of process 200, a determination is made whether a question of a second decision node of the second flowchart can be answered by a second stored answer. For example, with reference to FIG. 3, the server system may determine whether the question of decision node 307 of flowchart 300 can be answered by a second stored answer. Determining whether the question of decision node 307 can be answered by the second stored answer is advantageous in enabling the user to navigate through the plurality of flowcharts more efficiently, thereby reaching a goal state more quickly.

The second stored answer is similar to the first stored answer and may be at least partially based on stored information. In one example, the second stored answer may be the answer to question 501 of decision node 107 of flowchart 100. In another example, the second stored answer may be the answer to question 701 of decision node 111 of flowchart 100. In yet another example, the second stored answer may be at least partially based on an answer to a question of a decision node of a flowchart received prior to receiving the answer to question 501 of decision node 107 or the answer to question 701 of decision node 111. The stored information may include any previously collected user information as described above with respect to the first stored answer. In other examples, the stored information may include any retrievable information stored in an internal or external source.

As shown in process 200 of FIG. 2, blocks 219 to 221 of process 200 are performed in response to determining that the question of the second decision node of the second flowchart cannot be answered by the second stored answer. For example, the server system may determine that the question of decision node 307 cannot be answered by the second stored answer and thus the question of decision node 307 would need to be presented to the user to obtain an answer.

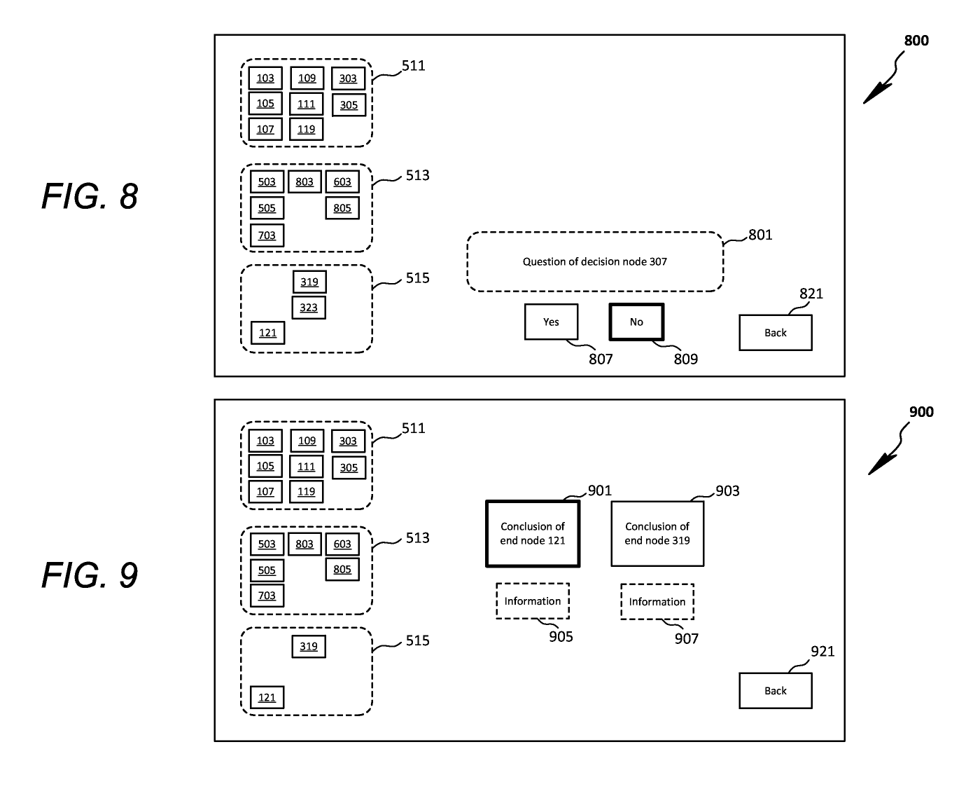

At block 219, the question of the second decision node of the second flowchart may be caused to be displayed on the GUI. For example, with simultaneous reference to FIGS. 3 and 8, the server system may cause the display of question 801 of decision node 307 of flowchart 300 on GUI 800. Question 801 may be displayed on GUI 800 having similar or identical visually distinguishing features as GUI element 403 of FIG. 4 and question 601 of FIG. 6. This is advantageous in helping the user quickly identify that question 801 originates from flowchart 300.

As shown in FIG. 8, GUI elements 807, 809 are displayed below question 801 and represent the answer choices to question 801. GUI elements 807, 809 function similarly to GUI elements 507, 509 of FIG. 5, respectively. Further, GUI 800 includes GUI element 821, which functions similarly to GUI element 521 of GUI 500. In the present example, selecting GUI element 821 via input to GUI 800 may cause the display of question 701 of decision node 111 and GUI 700. The user may therefore review question 701 or change their answer choice to question 701.

In the present example, decision node 307 is under consideration and thus the user has navigated through nodes 103-111 and 119 of flowchart 100, and nodes 303-305 of flowchart 300. Accordingly, as shown in FIG. 8, nodes 103-111 and 119 of flowchart 100 and nodes 303-305 of flowchart 300 are displayed in history display region 511 of GUI 800. Statements 503-505, 703, 803, 603 of statement nodes 103-105, 109, 119, 303, respectively, are displayed in task list region 513. Further, the conclusion of end node 113 is no longer a relevant conclusion because the answer “no” to question 701 of decision node 111 directs the user to end node 121, which eliminates the conclusion of end node 113 as a possible outcome. Accordingly, only the conclusions of end nodes 121, 323, 319 are displayed in outcome display region 515.

At block 221 of process 200, an answer to the question of the second decision node of the second flowchart may be received via input to the GUI. For example, with reference to FIG. 8, the user may input an answer to question 801 of decision node 307 via GUI 800 by selecting one of GUI elements 807, 809. In the present example, as depicted by the bold outline around GUI element 809 of FIG. 8, GUI element 809 is selected by the user. The answer “no” to question 801 is thus sent to the server system by the client device via the network and received by the server system. In some cases, the answer to question 801 may be stored as a stored answer in response to receiving the answer to question 801.

With reference to FIG. 3, statement node 317 and end node 319 of flowchart 300 logically flow from decision node 307 based on the answer “no” to question 801 of decision node 307. In one example, the statement of statement node 317 may be caused to be displayed on the GUI in response to selecting GUI element 809. This enables the user to understand the task or statement that logically follows decision node 307. The user may then be directed from statement node 317 to end node 319 and thus reach the conclusion of end node 319. In another example, the user may be directed from decision node 307 to end node 319 via statement node 317 without additional input from the user. The user thus reaches the goal state through the process of flowchart 300. In an example where flowchart 300 represents a process for determining whether to purchase a car, end node 319 may have a conclusion of “yes.” In addition, the conclusion of end node 323 is eliminated as a relevant conclusion when the answer “no” is received for question 801 of decision node 307. Thus, only the conclusions of end nodes 121, 319 would be displayed in outcome display region 515 in response to receiving the answer “no” to question 701 of decision node 111. Further, statement 805 of statement node 317 is displayed in task list region 513. Nodes 307, 317 are displayed in history display region 511 because the user navigated through decision node 307 and statement node 317 to reach end node 319.

With reference back to block 217 of process 200 and as represented by arrow 223, an answer to the question of the second decision node of the second flowchart may be pre-selected based on the second stored answer in response to determining that the question of the second decision node of the second flowchart can be answered by the second stored answer. For example, the server system may determine that question 801 of decision node 307 can be answered by the second stored answer and thus question 801 may be caused to be displayed on GUI 800 with a pre-selected answer based on the second stored answer. The pre-selected answer may be displayed by highlighting one of GUI elements 807, 809. In one example, the user may accept the pre-selected answer. Accepting the pre-selected answer may or may not require additional input from the user via GUI 800. In some cases, accepting the pre-selected answer may be automatic. In another example, the user may select a different answer. For example, the user may select a different answer via one of GUI elements 807, 809. In one example, the second stored answer may be “yes” and thus the answer “yes” to question 801 may be pre-selected. With reference to FIG. 3, nodes 309, 321, 323 logically flow from decision node 307 based on the answer “yes.” Thus, the user may reach end node 323 of flowchart 300 via statement nodes 309, 321 by accepting the pre-selected answer of “yes”. In another example, the second stored answer may be “no” and thus the answer “no” to question 801 may be pre-selected. The user may then reach end node 319 of flowchart 300 by accepting the pre-selected answer of “no”.

With reference back to block 207 of process 200 in FIG. 2, blocks 213, 215, 227 are performed in response to determining that the question of the first decision node of the second flowchart can be answered by the first stored answer. Blocks 213, 215 were previously described with reference to FIG. 7 while blocks 225, 227 are described below. At block 207, an answer to the question of the first decision node of the second flowchart may be pre-selected based on the first stored answer in response to determining that the question of the first decision node of the second flowchart can be answered by the first stored answer. For example, the server system may determine that question 601 of decision node 305 can be answered by the first stored answer and thus the question of decision node 305 may be caused to be displayed on GUI 600 with a pre-selected answer based on the first stored answer. The pre-selected answer may be displayed by highlighting one of GUI elements 607, 609. In one example, the user may accept the pre-selected answer. In another example, the user may select a different answer.

At block 227 of process 200, a determination is made whether a question of a third decision node of the second flowchart can be answered by a third stored answer. The third decision node of the second flowchart may be the same as or different from the second decision node of the second flowchart. In one example, with reference to FIG. 3, the server system may determine whether the question of decision node 307 of flowchart 300 can be answered by the third stored answer.

The third stored answer may be similar to the second stored answer and may be an answer at least partially based on stored information. In one example, the third stored answer may be the answer to question 501 of decision node 107 of flowchart 100. In another example, the third stored answer may be the answer to question 701 of decision node 111 of flowchart 100. In yet another example, the third stored answer may be at least partially based on an answer to a question of a decision node of a flowchart received prior to receiving the answer to question 501 of decision node 107 or the answer to question 701 of decision node 111 of flowchart 100. The stored information may include any previously collected user information as described above with respect to the first stored answer. In yet other examples, the stored information may include any retrievable information stored in an internal or external source.

As shown in process 200 of FIG. 2, blocks 229 to 231 of process 200 are performed in response to determining that the question of the third decision node of the second flowchart cannot be answered by the third stored answer. In one example, the server system may determine that the question of decision node 307 cannot be answered by the third stored answer. In response to the determination, the question of decision node 307 may be presented to the user to obtain an answer.

At block 229, the question of the third decision node of the second flowchart may be caused to be displayed on the GUI. For example, with simultaneous reference to FIGS. 3 and 8, the server system may cause the display of question 801 of decision node 307 of flowchart 300 on GUI 800. The user may select one of GUI element 807, 809 to answer question 801 of decision node 307.

At block 231 of process 200, an answer to the question of the third decision node of the second flowchart may be received via input to the GUI. For example, with reference to FIG. 8, the user may input an answer to question 801 of decision node 307 via GUI 800 by selecting one of GUI elements 807, 809. In this example, as depicted by the bold outline around GUI element 809 of FIG. 8, GUI element 809 is selected by the user. The answer “no” to question 801 is thus sent over the network by the client device and received by the server system. In some cases, the server system may store the received answer to question 801 as a stored answer.

As described above, with reference to FIG. 3, statement node 317 and end node 319 of flowchart 300 logically flow from decision node 307 based on the answer “no” to question 801 of decision node 307. The user may be directed to end node 319 via statement node 317 and thus reach the goal state using the process of flowchart 300.

With reference back to block 227 of process 200 and as represented by arrow 233, an answer to the question of the third decision node of the second flowchart may be pre-selected based on the third stored answer in response to determining that the question of the third decision node of the second flowchart can be answered by the third stored answer. For example, the server system may determine that the question of decision node 307 can be answered by the third stored answer and thus the question of decision node 307 may be caused to be displayed on GUI 800 with a pre-selected answer based on the third stored answer. The pre-selected answer may be displayed by highlighting one of GUI elements 807, 809. In one example, the user may accept the pre-selected answer. In another example, the user may change the pre-selected answer to a desired answer different from the pre-selected answer. In one example, the third stored answer may be “yes” and thus the pre-selected answer may be “yes.” With reference to FIG. 3, statement nodes 309, 321 and end node 323 logically flow from decision node 307 based on the answer “yes.” Thus the user may reach end node 323 of flowchart 300 via statement nodes 309, 321 by accepting the pre-selected answer “yes.” In another example, the third stored answer may be “no” and thus the pre-selected answer may be “no.” The user may reach end node 319 of flowchart 300 via statement node 317 by accepting the pre-selected answer “no.”

Process 200 may include causing display of GUI elements representing the conclusions of the end nodes reached for the first flowchart and the second flowchart on the GUI. For example, with reference to FIG. 9, the server system may cause the display of GUI elements 901, 903 representing the conclusions of end nodes 121, 319, respectively, on GUI 900. The user may select a final conclusion by selecting one of GUI elements 901, 903 via input to GUI 900. As shown in FIG. 9, the conclusions of end nodes 121, 319 are displayed on GUI elements 901, 903, respectively, to enable the user to quickly and conveniently identify, in a single viewing area, the recommended conclusions of the plurality of flowcharts. Further, GUI elements 901, 903 may have similar or identical visually distinguishing features as GUI elements 401, 403 of FIG. 4, respectively. This is advantageous in helping the user quickly identify that the conclusions of end nodes 121, 319 originate from flowcharts 100, 300, respectively.

As shown in FIG. 9, information 905, 907 may be caused to be displayed on GUI 900. Information 905, 907 may include information associated with the conclusions of end nodes 121, 319, respectively. The user may base their selection of a final conclusion at least partially on information 905, 907 and thus information 905, 907 serves to assist the user in selecting a final conclusion between the conclusions of end nodes 121, 319. In one example, information 905, 907 may include the overall user ratings of flowcharts 100, 300, respectively. The overall user rating of a flowchart may be based at least partially on the user ratings of the flowchart by previous users. The user rating of a flowchart may be based at least partially on the user ratings of at least some of the individual nodes of the flowchart. In one example, the user rating of a flowchart may be based on the aggregate of all the user ratings of each of the decision nodes in the flowchart.

In another example, information 905, 907 may include the overall user ratings of the conclusions of end nodes 121, 319, respectively. In some cases, the overall user rating of a conclusion of an end node may be based at least partially on the user ratings of the conclusion itself by previous users. In other cases, the overall user rating of a conclusion of an end node may be based at least partially on the user ratings of two or more nodes (e.g., decision nodes) along the logical path from which the end node flows. For example, with reference to FIG. 3, the overall user rating of the conclusion of end node 121 of flowchart 100 may be based on the aggregate of all the user ratings of nodes 107, 111, 121.

In yet another example, information 905, 907 may include the percentage of previous users who selected each conclusion of end nodes 121, 319, respectively, as their final conclusion. In one such example, the percentage may be based on the selections of previous users who selected between the conclusions of end nodes 121, 319. In another such example, the percentage may be based on the selections of all previous users among the conclusions of all end nodes of flowcharts 100, 300. Information 905, 907 may further include the overall user ratings of the authors of the flowcharts 100, 300, respectively.

In some cases, GUI 900 may include GUI elements (not shown) which, when selected by a user, request the display of one of flowcharts 100, 300 for which end nodes 121, 319, respectively, were reached. In one example, the GUI elements may be the conclusions of the end nodes displayed in outcome display region 515. In another example, the GUI elements may be separate GUI elements (not shown) displayed on GUI 900. The user may request the display of flowcharts 100 or 300 by selecting one of the GUI elements via input to GUI 900. In response to receiving the request, at least a portion of the corresponding flowchart may be caused to be displayed on the GUI. For example, the entire flowchart or only a portion of the flowchart may be displayed on the GUI. In some cases, at least a portion of the logical path between the start node and the reached end node may be highlighted on the flowchart. The highlighted logical path enables the user to quickly identify and review the process steps involved in reaching the conclusion of the end node. The GUI may enable the user to navigate through each node of the flowchart by selecting the node of the flowchart.

FIG. 1000 illustrates GUI 1000 displaying flowchart 100 in response to receiving a request to display flowchart 100. As shown in FIG. 100, flowchart 100 is displayed where the logical path from start node 101 to end node 121, including nodes 103, 105, 107, 109, 111, 119, is highlighted in bold. Accordingly, the highlighted logical path enables the user to review the process steps involved in reaching the conclusion of end node 121. Understanding the process steps may help the user determine the final conclusion to select. It should be recognized that in other examples, the logical path may be highlighted in various other ways. Further, only a portion of flowchart 100 may be displayed.

Process 200 may further include receiving a selection of a final conclusion among the conclusions of the reached end node of the plurality of flowcharts. For example, with reference to FIG. 9, the user may select a final conclusion between the conclusions of end nodes 121, 319 by selecting one of GUI elements 901, 903, respectively. The user may select the final conclusion based at least partially on the conclusions of end nodes 121, 319 and on information 905, 907. By selecting a final conclusion, the user reaches the goal state. In this example, as shown by the bold outline around GUI element 901 of FIG. 9, the conclusion of end node 121 of flowchart 100 is selected as the final conclusion by selecting, via input to GUI 900, GUI element 901. The selection is sent to the server system by the client device via the network and received by the server. Accordingly, the user is able to reach the desired goal state quickly and efficiently using process 200.

Although process 200 is described with reference to blocks 201-231, it should be appreciated that in some cases, one or more blocks of process 200 may be optional and additional blocks may also be performed. For example, flowcharts 100, 300 may include additional decision nodes and thus process 200 may include one or more additional blocks similar to blocks 203-231 as described above to enable the user to reach an end node of each flowchart 100, 300.

Further, it should be recognized that in other examples, the user may select more than two flowcharts to reach the goal state. For example, the user may select five flowcharts for reaching the goal state and thus reach five conclusions of five end nodes using process 200. Reaching more conclusions may be advantageous in providing statistical confidence in the conclusions reached. For example, four out of the five conclusions reached may be identical and thus the user may feel more confident selecting a final conclusion corresponding to the conclusion of a majority of the selected flowcharts.

Although in the above example, flowchart 100 is the first flowchart and flowchart 300 is the second flowchart, it should be appreciated that in other examples, flowchart 300 may be the first flowchart while flowchart 100 may be the second flowchart. In one example, the first flowchart may have fewer nodes than the second flowchart. In another example, the first flowchart may have fewer decision nodes than the second flowchart. In yet another example, the first flowchart may have a higher user rating or may have an author with a higher user rating than the second flowchart. Further, the first flowchart may have a greater number of decision nodes having questions that can answered by stored answers or by answers to questions of decision nodes of another flowchart of the plurality of flowcharts than the second flowchart. The stored answers may be answers at least partially based on stored information as described above with respect to the first stored answer.

In addition, while blocks 201-231 of process 200 are shown in a particular order in FIG. 2, it should be appreciated that these blocks may be performed in any order. For instance, in one example, process 200 may guide the user through each flowchart of the plurality of flowcharts in series. In one such example, with reference to FIG. 2, blocks 213, 215 may be performed prior to block 207. Thus, an end node of the first flowchart may be reached before any determination is made whether a question of a decision node of the second flowchart can be answered by a stored answer. In another example, process 200 may guide the user through each flowchart of the plurality of flowcharts in parallel. In one such example, with reference to FIG. 2, blocks 213, 215 may be performed after block 207. Process 200 thus alternates between a question of a decision node of the first flowchart and a question of a decision node of the second flowchart, thereby navigating through the two flowcharts of the plurality of flowcharts in parallel.

In cases where the plurality of flowcharts includes three or more flowcharts, process 200 may guide the user through each flowchart in series or in parallel and in a sequence determined at least partially by the total number of nodes in each flowchart, the total number of decision nodes in each flowchart, the total number of decision nodes in each flowchart having questions that can be answered by stored answers, the overall user rating of each flowchart, or the overall user rating of the author of each flowchart.

As described above, each received answer to a question of a decision node of a flowchart may be stored as a stored answer. All stored answers of a user may be stored, for example, in a database under a user profile. The server system may include the database or the database may be external from the server system and accessed by the server system. The stored answers may enable easier future navigation of flowcharts using process 200 where the user may reach a conclusion quicker by having to answer fewer questions.

Although FIGS. 4-9 depict GUIs 400, 500, 600, 700, 800, 900, 1000 as separate GUIs, it should be appreciated that GUIs 400, 500, 600, 700, 800, 900 may be the same GUI but with different GUI elements and regions that are displayed at different times on the GUI.

Further, although in the examples described above, the relevant conclusions are displayed in outcome display region 515 while non-relevant conclusions are not displayed in outcome display region 515, it should be recognized that in other examples, various other methods may be implemented to distinguish the relevant conclusions from the non-relevant conclusions. In one example, both the relevant and non-relevant conclusions may be displayed in outcome display region 515. However, the relevant conclusions may be visually highlighted such that the user may easily identify the relevant conclusions from the non-relevant conclusions.

The GUIs described above for carrying out aspects of process 200 may be integrated with GUIs for creating flowcharts. For example, a website may enable users to both create flowcharts and reach a goal state using a plurality of flowcharts. The flowcharts created by some users may be used by other users to reach a goal state in accordance with the examples described herein. In one example, the GUI for creating flowcharts may encourage users to reuse existing questions of decision nodes of flowcharts created by other users. For example, the GUI may provide a pull-down menu listing all existing questions related to the goal state for which a user is creating a flowchart. The user thus may select existing questions from the pull-down menu to create a flowchart. Only when the list of existing questions does not contain a question required by the user does the GUI allow the user to introduce a new or unique question. By encouraging users to create flowcharts using existing questions, the answers to questions of one flowchart can be used to answer the questions of another flowchart. As a result, the created flowcharts enable users to more efficiently reach a goal state using process 200.

Although in process 200, the determination of whether a question of a decision node can be answered by a stored answer is performed only on the decision nodes of the second flowchart, it should be recognized that in other examples, the determination may be performed on the decision nodes of the first flowchart as well. For example, FIG. 11 illustrates an exemplary process 1100 for reaching a goal state using a plurality of flowcharts. The blocks of process 1100 with identical reference numerals to those of process 200 of FIG. 2 have similar or identical construction and operation. Blocks 201, 203, 205, 209, 211 of process 1100 are described above with reference to process 200 of FIG. 2.

At block 1101 of process 1100, a determination is made whether a question of a first decision node of the first flowchart can be answered by a first stored answer. For example, with reference to FIG. 3, the server system may determine whether the question of decision node 107 of flowchart 100 can be answered by a first stored answer. As described above, the first stored answer may be at least partially based on stored information. In one example, the first stored answer may be at least partially based on an answer to a question of a decision node of a flowchart received prior to block 1101. The stored information may include any previously collected user information. In other examples, the stored information may include any retrievable information stored in an internal or external source.

As shown in FIG. 11, blocks 203, 205 are performed in response to determining that the question of the first decision node of the first flowchart cannot be answered by the first stored answer. For example, the server system may determine that the question of decision node 107 of flowchart 100 cannot be answered by the first stored answer. In response to the determination, the question of decision node 107 may be presented to the user to obtain an answer. As described above, the question of the first decision node of the first flowchart is caused to be displayed on the GUI at block 203 and an answer to the question of the first decision node of the first flowchart is received via input to the GUI at block 205.

At block 1103 of process 1100, a determination is made whether a question of a first decision node of the second flowchart can be answered by a second stored answer. For example, with reference to FIG. 3, the server system may determine whether the question of decision node 305 of flowchart 300 can be answered by a second stored answer. The second stored answer may be an answer at least partially based on stored information. In one example, the second stored answer may be the answer to the question of decision node 107 of flowchart 100. In another example, the second stored answer may be at least partially based on an answer to a question of a decision node of a flowchart received prior to block 1103. The stored information may include any previously collected user information. In other examples, the stored information may include any retrievable information stored in an internal or external source.

As shown in FIG. 11, blocks 209, 211 are performed in response to determining that the question of the first decision node of the second flowchart cannot be answered by the second stored answer. For example, the server system may determine that the question of decision node 305 of flowchart 300 cannot be answered by the second stored answer. In response to the determination, the question of decision node 305 may be presented to the user to obtain an answer. As described above, a question of the first decision node of the second flowchart is caused to be displayed on the GUI at block 209 and an answer to the question of the first decision node of the second flowchart is received via input to the GUI at block 211.

Referring back to block 1103 and as represented by arrow 1107, an answer to the question of the first decision node of the second flowchart may be pre-selected based on the second stored answer in response to determining that the question of the first decision node of the second flowchart can be answered by the second stored answer. For example, the server system may determine that the question of decision node 305 can be answered by the second stored answer. In response to the determination, the question of decision node 305 may be caused to be displayed on the GUI with a pre-selected answer based on the second stored answer. The user may accept the pre-selected answer or selected a different answer.

Referring back to block 1101, block 1103 may be performed in response to determining that the question of the first decision node of the first flowchart can be answered by the first stored answer. Block 1103 is described above. In some cases, in response to determining that the question of the first decision node of the first flowchart can be answered by the first stored answer, an answer to the question of the first decision node of the first flowchart may be pre-selected based on the first stored answer prior to performing block 1103. For example, the server system may determine that the question of decision node 107 can be answered by the first stored answer. In response to the determination, the question of decision node 107 may be caused to be displayed on the GUI with a pre-selected answer based on the first stored answer. The user may accept the pre-selected answer or select a different answer.

While the blocks of process 1100 are shown in a particular order in FIG. 11, it should be appreciated that these blocks may be performed in any order. Further, it should be appreciated that in some cases, one or more blocks of process 1100 may be optional and additional blocks may also be performed in accordance with the examples described herein.

In one exemplary application of processes 200, 1100, a user may invite trusted acquaintances who are knowledgeable in the specific goal state, to create flowcharts for reaching the specific goal state. The user may then carry out process 200 using the flowcharts created by the trusted acquaintances to reach the goal state. Because the flowcharts are created by trusted acquaintances of the users, the user may have greater confidence in conclusions reached using the flowcharts. Additionally, the user may reach a conclusion based on the flowcharts of the trusted acquaintances without having to provide personal information to the acquaintances. In particular, the user may answer personal questions presented by the flowcharts without having to share those answers with the acquaintances. According, the user may reach the specific goal state using process 200 with greater confidence, efficiency, and privacy.

In another exemplary application, processes 200, 1100 may be used to interview potential candidates for a desired job, task, or role. For example, interviewers who are seeking a candidate for a specific role may each create a flowchart for determining whether to accept a candidate for the role. Each candidate who desires to attain the role may carry out process 200 using the flowcharts created by the interviewers. The decision of whether to accept a candidate for the role may be based on the conclusions reached by each of the flowcharts using process 200. For example, a candidate may attain acceptances based on the conclusions of four out of five flowcharts of the interviewers using process 200 and thus be accepted for the role. Accordingly, process 200 may be implemented to quickly and efficiently screen candidates for a desired job, task, or role. It should be recognized that for such an application, processes 200, 1100 and the GUIs for carrying out process 200, 1100 may be modified such that the conclusions reached for each flowchart are not displayed to the candidate.

### 3. System and Environment for Reaching a Goal State Using a Plurality of Flowcharts

FIG. 12 illustrates an exemplary system and environment for carrying out aspects of the process described herein. As shown in FIG. 12, client device 1207 connects to server system 1201 via a network 1205. Client device 1207 may be any computing device capable of displaying the GUIs described herein and receiving selections, instructions, and answers to questions via the GUIs. For example, client computer may be a mobile device (e.g., smart phone, tablet computer, PDA, gaming console, smart watch, smart glasses, telephone, interactive voice response systems, etc.), a notebook computer, or a desktop computer. In some cases, client device 1207 may run client software such as an internet browser (i.e., web browser), flash plug-ins, and any other software useful to show web pages to the computer user. Additionally, client device 1207 may be configured to receive a message from server system 1201 by email, Short Message Service (SMS), Multimedia Message Service (MMS), or Instant Messaging (IM).

Network 1205 may be a TCP/IP network (i.e., Internet network). In other cases, network 1205 may be a LAN (Local Area Network), WAN (Wide Area Network), wireless network, point-to-point network, or other configurations. Server system 1201 and client device 1207 may communicate using TCP/IP and, at a higher network level, use other common Internet protocols to communicate, such as HTTP, FTP, AFS, WAP, etc.

In one example, a user of client device 1207 may use a web browser to transmit, across network 1205, a request for a web page having the GUI described herein. The request may be, for example, a URL (Uniform Resource Locator) for the web page. Server system 1201 may receive the request from client device 1207 and in response, may package and transmit across network 1205 the requested web page to client device 1207, thereby causing display of the GUI described herein on the display screen of client device 1207. The displayed GUI may include, for example, various GUI elements, display regions, questions or decision nodes, statements of statement nodes, and conclusions of end nodes as described herein. Additionally, server system 1201 may receive, via input to the GUI displayed on client device 1207, various requests, instructions, or answers to questions of decision nodes of flowcharts. In response to receiving such requests, instructions, or answers, server system 1201 may cause display of the GUIs described herein on client device 1207. Additionally, server system 1201 may determine whether a question of a decision node of a flowchart may be answered by a stored answer.

It should be recognized that causing display of the graphical user interface described herein includes causing display of the graphical user interface on a user device where the entire graphical user interface may be viewed by scrolling or panning. Similarly, causing display of a node in a display region of the graphical user interface includes displaying the node on a user device where the node may be viewed by scrolling or panning.

Server system 1201 and client device 1207 may be computer systems, such as, personal computers, computer work stations, or computer servers. An exemplary computer system is described in detail below with reference to FIG. 12.

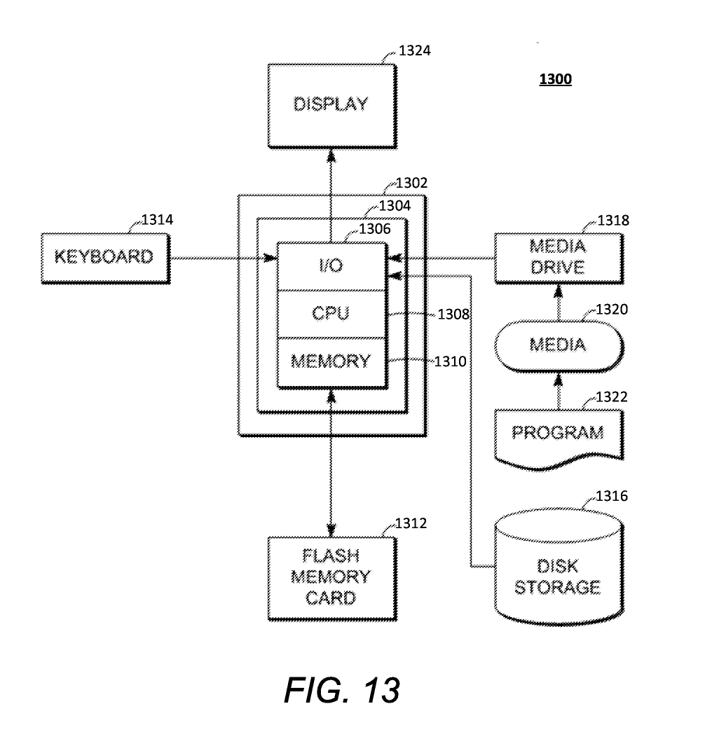

FIG. 13 depicts computing system 1300 with a number of components that may be used to perform the above-described processes. The main system 1302 includes a motherboard 1304 having an input/output (“I/O”) section 1306, one or more central processing units (“CPU”) 1308, and a memory section 1310, which may have a flash memory card 1312 related to it. The I/O section 1306 is connected to a display 1324, a keyboard 1314, a disk storage unit 1316, and a media drive unit 1318. The media drive unit 1318 can read/write a non-transitory computer-readable medium 1320, which can contain programs 1322 and/or data that may be executed by CPU 1308. In some cases, the media drive unit 1318 may be external (e.g., network drive or cloud storage) to computing system 1300 and accessed by computing system 1300 via a network.

Where computer system 1300 is a server system, programs 1322 may include software code for carrying out processes for reaching a goal state using a plurality of flowcharts as described herein. For example, programs 1322 may include software code for causing display of and operation of the GUIs described herein. In addition, programs 1322 may include software code for determining whether a question of a decision node of a flowchart can be answered by a stored answer. The software code may be in any conventional computer language. In one example, programs 1322 may include software code for a web page having the graphical user interface described herein. The web page may be written in hyper-text mark-up language (HTML). Accordingly, the software code described above may be executed by CPU 1308 to cause the display of the GUIs described herein and to carry out processes for reaching a goal state using a plurality of flowcharts described herein.

Where computer system 1300 is a client device, programs 1322 may include software code for a web browser application. The memory section 1310 can store downloaded web pages having the GUIs described herein. CPU 1308 may execute the web browser application code to display the downloaded web pages having the GUIs described herein on display 1324. A user may interact with the GUIs displayed on display 1324 via a keyboard and/or a selector device (e.g., mouse, touch screen) to select GUI elements.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed is:

1. A computer implemented method for reaching a goal state using a plurality of flowcharts, each flowchart of the plurality of flowcharts representing a process for reaching the goal state, the method comprising:
receiving, via input to a graphical user interface, a selection of the plurality of flowcharts, the plurality of flowcharts include a first flowchart and a second flowchart;
causing display of a question of a first decision node of the first flowchart on the graphical user interface;
receiving, via input to the graphical user interface, an answer to the question of the first decision node of the first flowchart;
determining whether a question of a first decision node of the second flowchart can be answered by a first stored answer; and
in response to determining that the question of the first decision node of the second flowchart cannot be answered by the first stored answer:
causing display of the question of the first decision node of the second flowchart on the graphical user interface;
receiving, via input to the graphical user interface, an answer to the question of the first decision node of the second flowchart;
causing display of a question of a second decision node of the first flowchart, wherein the second decision node of the first flowchart logically flows from the first decision node of the first flowchart based on the answer to the question of the first decision node of the first flowchart; and
receiving, via input to the graphical user interface, an answer to the question of the second decision node of the first flowchart.

2. The computer implemented method of claim 1, wherein the first stored answer is one of:
an answer at least partially based on stored user information,
the answer to the question of the first decision node of the first flowchart, and
an answer to a question of a decision node of a flowchart received prior to receiving the answer to the question of the first decision node of the first flowchart.

3. The computer implemented method of claim 1, further comprising:
in response to determining that the question of the first decision node of the second flowchart cannot be answered by the first stored answer:
determining whether a question of a second decision node of the second flowchart can be answered by a second stored answer, wherein the second decision node of the second flowchart logically flows from the first decision node of the second flowchart based on the answer to the question of the first decision node of the second flowchart; and
in response to determining that the question of the second decision node of the second flowchart cannot be answered by the second stored answer:
causing display of the question of the second decision node of the second flowchart on the graphical user interface; and
receiving, via input to the graphical user interface, an answer to the question of the second decision node of the second flowchart.

4. The computer implemented method of claim 1, further comprising:
in response to determining that the question of the first decision node of the second flowchart can be answered by the first stored answer:
causing display of a question of a second decision node of the first flowchart, wherein the second decision node of the first flowchart logically flows from the first decision node of the first flowchart based on the answer to the question of the first decision node of the first flowchart; and
receiving, via input to the graphical user interface, an answer to the question of the second decision node of the first flowchart;
determining whether a question of a third decision node of the second flowchart can be answered by a third stored answer, wherein the third decision node of the second flowchart logically flows from the first decision node of the second flowchart based on the first stored answer; and
in response to determining that the question of the third decision node of the second flowchart cannot be answered by the third stored answer:
causing display of the question of the third decision node of the second flowchart on the graphical user interface; and
receiving, via input to the graphical user interface, an answer to the question of the third decision node of the second flowchart.

5. The computer implemented method of claim 4, further comprising:
in response to determining that the question of the first decision node of the second flowchart can be answered by the first stored answer:
causing display of the question of the first decision node of the second flowchart on the graphical user interface; and
causing display of a pre-selected answer to the question of the first decision node of the second flowchart on the graphical user interface, wherein the pre-selected answer is based on the first stored answer.

6. The computer implemented method of claim 1, wherein causing display of a question of a first decision node of the first flowchart on the graphical user interface includes causing display of a statement of a statement node of the first flowchart on the graphical user interface, and wherein the first decision node of the first flowchart logically flows from the statement node of the first flowchart.

7. The computer implemented method of claim 1, further comprising causing display of a statement of a statement node of the first flowchart on the graphical user interface in response to receiving the answer to the question of the first decision node of the first flowchart, wherein the statement node of the first flowchart logically flows from the first decision node of the first flowchart.

8. The computer implemented method of claim 1, wherein causing display of the question of the second decision node of the first flowchart is performed after determining whether the question of the first decision node of the second flowchart can be answered by the first stored answer.

9. The computer implemented method of claim 1, wherein causing display of the question of the second decision node of the first flowchart is performed prior to determining whether the question of the first decision node of the second flowchart can be answered by the first stored answer.

10. The computer implemented method of claim 1, wherein a total number of decision nodes of the first flowchart is less than a total number of decision nodes of the second flowchart.

11. The computer implemented method of claim 1, wherein a total number of decision nodes of the first flowchart having questions that can be answered by stored answers is greater than a total number of decision nodes of the second flowchart having questions that can be answered by stored answers.

12. The computer implemented method of claim 1, wherein an overall user rating of the first flowchart is higher than an overall user rating of the second flowchart.

13. The computer implemented method of claim 1, wherein causing display of the question of the first decision node of the first flowchart includes causing display of an overall user rating of the question of the first decision node of the first flowchart on the graphical user interface.

14. The computer implemented method of claim 1, further comprising receiving, via input to the graphical user interface, a user rating of the question of the first decision node of the first flowchart.

15. The computer implemented method of claim 1, further comprising receiving, via input to the graphical user interface, a request to display a previous question of a decision node of the plurality of flowcharts, wherein prior to receiving the request to display the previous question, an answer to the previous question was received or a determination was made that the previous question can be answered by a stored answer.

16. The computer implemented method of claim 1, wherein the graphical user interface only permits a user to navigate down a flowchart of the plurality of flowcharts and restricts the user from navigating back up the flowchart.

17. The computer implemented method of claim 1, wherein the graphical user interface includes an outcome display region for displaying at least one relevant end node, and further comprising causing display of at least one relevant end node in the outcome display region, wherein the at least one relevant end node logically flows from the first decision node of the first flowchart or the first decision node of the second flowchart.

18. The computer implemented method of claim 1, wherein an end node of a flowchart of the plurality of flowcharts is reached while navigating through the plurality of flowcharts, and further comprising:
receiving, via input to the graphical user interface, a request to display the flowchart; and
causing display of at least a portion of the flowchart on the graphical user interface, wherein at least a portion of a logical path from a start node to the end node of the flowchart is highlighted.

19. The computer implemented method of claim 1, wherein a user reaches a first end node of the first flowchart and a second end node of the second flowchart, and further comprising causing display of a conclusion of the first end node and a conclusion of the second end node on the graphical user interface.

20. The computer implemented method of claim 19, further comprising causing display of:
a first overall user rating of the first flowchart and a second overall user rating of the second flowchart, wherein the first overall user rating is based at least partially on user ratings of a plurality of decision nodes of the first flowchart, and wherein the second overall user rating is based at least partially on user ratings of a plurality of decision nodes of the second flowchart, or
a percentage of previous users who selected the conclusion of the first end node and a percentage of previous users who selected the conclusion of the second end node.

21. The computer implemented method of claim 19, further comprising receiving, via input to the graphical user interface, a selection of the conclusion of the first end node or the conclusion of the second end node as a final conclusion.

22. The computer implemented method of claim 1, wherein the graphical user interface includes a task list region for displaying a task list of each flowchart of the plurality of flowcharts, wherein a user navigates through a statement node of the first flowchart, and further comprising causing display of a statement of the statement node of the first flowchart in the task list region.

23. The computer implemented method of claim 1, wherein the graphical user interface includes a history display region for displaying a node of a flowchart of the plurality of flowcharts through which a user navigated, and further comprising causing display of the first decision node of the first flowchart in the history display region in response to receiving the answer to the question of the first decision node of the first flowchart.

24. A system for reaching a goal state using a plurality of flowcharts, each flowchart of the plurality of flowcharts representing a process for reaching the goal state, the system comprising:
a server system comprising a processor operable to:
receive, via input to a graphical user interface, a selection of the plurality of flowcharts, the plurality of flowcharts including a first flowchart and a second flowchart;
cause display of a question of a first decision node of the first flowchart on the graphical user interface;
receive, via input to the graphical user interface, an answer to the question of the first decision node of the first flowchart;
determine whether a question of a first decision node of the second flowchart can be answered by a first stored answer; and
in response to determining that the question of the first decision node of the second flowchart cannot be answered by the first stored answer:
cause display of the question of the first decision node of the second flowchart on the graphical user interface;
receive, via input to the graphical user interface, an answer to the question of the first decision node of the second flowchart;
cause display of a question of a second decision node of the first flowchart, wherein the second decision node of the first flowchart logically flows from the first decision node of the first flowchart based on the answer to the question of the first decision node of the first flowchart; and
receive, via input to the graphical user interface, an answer to the question of the second decision node of the first flowchart.

25. A non-transitory computer-readable storage medium containing computer executable instructions for reaching a goal state using a plurality of flowcharts, each flowchart of the plurality of flowcharts representing a process for reaching the goal state, the computer executable instructions comprising instructions for:
receiving, via input to a graphical user interface, a selection of the plurality of flowcharts, the plurality of flowcharts including a first flowchart and a second flowchart;
causing display of a question of a first decision node of the first flowchart on the graphical user interface;
receiving, via input to the graphical user interface, an answer to the question of the first decision node of the first flowchart;
determining whether a question of a first decision node of the second flowchart can be answered by a first stored answer; and
in response to determining that the question of the first decision node of the second flowchart cannot be answered by the first stored answer:
causing display of the question of the first decision node of the second flowchart on the graphical user interface;
receiving, via input to the graphical user interface, an answer to the question of the first decision node of the second flowchart;
causing display of a question of a second decision node of the first flowchart, wherein the second decision node of the first flowchart logically flows from the first decision node of the first flowchart based on the answer to the question of the first decision node of the first flowchart; and
receiving, via input to the graphical user interface, an answer to the question of the second decision node of the first flowchart.
